(19) United States
(12) Patent Application Publication
(10) Pub. No.: US 2016/0165277 A1
(43) Pub. Date: Jun. 9, 2016

(54) MEDIA METRICS ESTIMATION FROM LARGE POPULATION DATA

(71) Applicant: Google Inc., Mountain View, CA (US)

(72) Inventors: Roman Kirillov, London (GB); Nicolas Remy, Paris (FR); James Robert Koehler, Boulder, CO (US); Simon Michael Rowe, Berkshire (GB); Xiaojing Wang, Jersey City, NY (US); Diane Lambert, Summit, NJ (US)

(21) Appl. No.: 13/843,683

(22) Filed: Mar. 15, 2013

(51) Int. Cl. H04N 21/24

(52) U.S. Cl. CPC H04N 21/2407

(57) ABSTRACT

A method, executed by a processor, for estimating media metrics from large population data includes formatting and storing panel data, the panel data comprising observed viewing data of a plurality of individual panelists and demographic data for the plurality of panelists, the panel being drawn from a large population; accessing the large population data, the large population data comprising household-level viewing data and household level demographics; training a model to estimate viewing audience size based on the observed panel data; estimating, using the trained model, audience size for each household in the large population data; estimating a viewing score for each individual viewer in a plurality of households in the large population data; and combining the estimates of audience size and viewing score to produce probabilities that each of the viewers in the household viewed a specific media event.

### BACKGROUND

Program providers supply content segments to viewers over various communications networks. Content segments may include broadcast television programs. Content segments may include video programs streamed, for example, over the Internet. Content segments also may include video advertisements that accompany, or in some way relate to the video programs. Content segments may be accessed using an application on a mobile device. Other content segments and other distribution methods are possible.

Sponsors provide sponsored content segments to promote products and services. Sponsors may use one or more different media (e.g., television, radio, print, online) to promote the products and services. Sponsors may create a promotional campaign that uses sponsored content segments appearing in different media. The sponsored content segments may be for the same products and services although the sponsored content segments appear in different media. Thus, individuals may be exposed to sponsored content segments in a first media, a second media, and so on.

Program providers may be interested in knowing what content segments are accessed or viewed by which viewers. Sponsors may want to know how effective their promotional campaign is. One way to determine this “viewing history” is by sampling a large population and making inferences about the viewing history based on the sample results. One way to determine promotional campaign effectiveness is to measure media consumption metrics such as an amount of time an individual spends exposed to the media, a number of times a specific content segment has seen and/or heard by the individual, and the number of exposures to sponsored content segments among the different media, for example. These techniques may be inaccurate and unreliable, and may be costly to implement.

### SUMMARY

A method, executed by a processor, for estimating media metrics from large population data includes formatting and storing panel data, the panel data comprising observed viewing data of a plurality of individual panelists and demographic data for the plurality of panelists, the panel being drawn from a large population; accessing the large population data, the large population data comprising household-level viewing data and household level demographics; training a model to estimate viewing audience size based on the observed panel data; estimating, using the trained model, audience size for each household in the large population data; estimating a viewing score for each individual viewer in a plurality of households in the large population data; and combining the estimates of audience size and viewing score to produce probabilities that each of the viewers in the household viewed a specific media event.

### DESCRIPTION OF THE DRAWINGS

The detailed description refers to the following Figures in which like numerals refer to like items, and in which:

FIG. 1 illustrates an example of the overall process to estimate media metrics from large population data;

FIG. 2 illustrates an example of environment in which media consumption for a large population may be inferred from a small population sample;

FIG. 3A illustrates an example of media consumption;

FIG. 3B illustrates a relationship between or among a recruited panel and a population represented by STB log data;

FIGS. 4A and 4B illustrate an example of a media metrics estimation system; and

FIGS. 5A-5C are flowcharts illustrating example media consumption estimation methods executed by the system of FIG. 4.

### DETAILED DESCRIPTION

Program providers supply content segments to viewers over various communications networks. Content segments may include broadcast television programs. Content segments may include video programs streamed, for example, over the Internet. Content segments also may include video advertisements that accompany, or in some way relate to the video programs. Content segments may be accessed using an application on a mobile device. Other content segments and other distribution methods are possible.

Sponsors provide sponsored content segments to promote products and services. Sponsors may use one or more different media (e.g., television, radio, print, online) to promote the products and services. Sponsors may create a promotional campaign that uses sponsored content segments appearing in different media. The sponsored content segments may be for the same products and services although the sponsored content segments appear in different media. Thus, individuals may be exposed to sponsored content segments in a first media, a second media, and so on.

Program providers may be interested in knowing what content segments are accessed or viewed by which viewers. One way to determine this “viewing history” is by sampling a large population and making inferences about the viewing history based on the sample results. One way to sample a viewing population is through the use of individual panelists (viewers in the sample population) and metering devices that record and report on the individual panelists' viewing history. For example, an individual panelist (i.e., a viewer) may agree to installation of a meter at the panelist's residence. The meter records the individual panelist's television viewing and Internet activity, and reports the data to a remote server. Note that this approach works in a household having more than one viewer. For example, each household member may be recruited as a panelist. Alternately, a subset of the household members may participate as panelists. Note that the panelists may agree to being measured. Furthermore, individual panelists would agree to sign in to measurement, but and measurement may be suspended at any time (incognito) by a panelist.

In contrast to metering individual panelists, viewing history data may be collected by a single metering device installed at a household. For example, a television set top box (STB) may record television viewing data. This approach cannot distinguish viewing by individual household members, but may be less costly to implement.

Sponsors may want to know how effective their promotional campaigns are. One way to determine effectiveness is to measure media consumption metrics such as an amount of time an individual spends exposed to the media, a number of times a specific content segment has seen and/or heard by the individual, and the number of exposures to sponsored content segments among the different media, for example.

Reach is an example of a media consumption metric. In the context of an individual, reach is a binary metric; either an individual has been exposed to the media (for example, exposed to a sponsored content segment) or the individual has not been so exposed. Reach may be defined on an individual basis or over a population group. However, for a population, reach may be expressed as a percentage. Reach also may be defined over multiple media types. Reach may be measured by a panel and overall reach of the population from which the panel is drawn may be estimated or inferred from the panel data.

As noted above, one way to obtain high quality data for a media consumption study is to recruit a statistically representative sample of households and individuals and install meters on every media device of the participating households so as to record the viewing date, time, audio signature, and identity of the panelists viewing the media. In this approach, all household members and guests may be required to register their media viewing using, for example, a remote control. While providing high quality user-level media consumption data, this approach is hard to scale to a large population due to high recruitment and meter installation costs. For example, a small, high quality panel may not provide statistically reliable data for all population segments of interest because of the costs associated with obtaining the data from so many possible population groups. Thus, the cost associated with building a large-scale, high quality panel, where individual viewers in a household are metered may be prohibitive.

To overcome this problem with determining television consumption data at the level of individual users in a household, disclosed herein are methods and systems that infer individual consumption in a large population using a model that is trained on a sample of high quality television program viewing data. The systems and methods disclosed herein begin by recruiting a high quality panel, or acquiring data from an existing high quality panel. Note that such a panel may record data form multiple types of media. For example, the panel may be a single source panel (SSP) that records media consumption data for television viewing, Internet activity, radio listening, and other types of media consumption. The SSP also records panelist demographic data.

Next, considering for example, television as the media being consumed, the systems and methods use data such as that which may be obtained by buying television STB logs data from cable or satellite TV providers. This approach to acquiring data on a large scale may be less costly than attempting to record such data using individually-metered panelists. One limitation of data from STB logs is that with a STB, television viewing logged at the household level. This household level data recordation may prevent direct calculation of many television audience measures that require individual viewer-level data.

To overcome this limitation with STB log data, the systems and methods use a process that infers individual viewing from collected household-level viewing data. One aspect of this process of household-to-individual conversion is to take into account the fact that watching television often is a group activity. Another aspect of this process is to do soft classification as opposed to hard classification for every television viewing event observed in the household. Here, a television viewing event may be defined as an uninterrupted period that a television was tuned to a specific channel. The process includes estimating a size of the household audience and then splitting the estimate among all viewers in the household. Individual viewer-level television viewing probabilities, as outputs of the process then are aggregated to compute television audience measures, such as reach and target rating points. In addition, the process may be extended to estimate incremental reach.

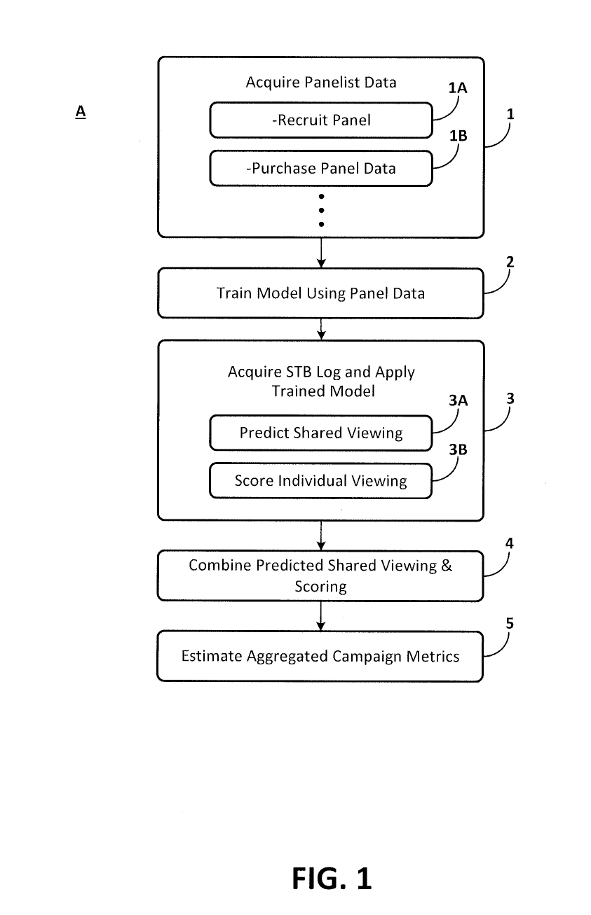

FIG. 1 illustrates an example of an overall process to measure television viewing based on data from STB logs. The process involves training a model at the granular (e.g., individual) television viewing event level, predicting viewing behavior from the STB data, and then producing aggregated audience measures on top of the estimated viewing probabilities. In FIG. 1, media metrics estimation process A includes block 1, acquire panelist data for television viewing. The panelist data of block 1 may be acquired by (block 1A) recruiting a panel and monitoring television viewing by the panelists. Alternately, the panelist data may be purchased (block 1B). The panelist data may include demographic data and television viewing data, broken down by television viewing events. The television viewing events data and the demographic data may comprise a vector of variables or predictors X. The demographic data may include age, gender, education level, occupation type, geographic location, and other data, for example The television viewing data may include day and time, channel, etc.

Block 2 trains a model, using panel data for an individual, to estimate all model parameters. A regression model, for example, may be used to estimate the coefficients of the predictor X.

In block 3, the trained model is applied to STB log data obtained for a sample of households in the population. Block 3 may include two stages. In a first stage (block 3A), shared viewing of the television viewing events is predicted using the trained model applied to STB log data. In a second stage (block 3B), individual viewing is scored.

In block 4, the shared viewing predictions and individual scoring of block 3 are combined. Finally, in block 5 aggregated campaign metrics such as reach and target rating point are estimated using the processed STB log data. The processes of FIG. 1 are described in more detail below.

Note that for a single-viewer household (i.e., a household supplying the STB log data), the household television viewing directly converts to individual scoring, and thus the modeling of block 3 is not needed.

For a two-viewer household, each television viewing event is a manifestation of three possible viewer-level television viewing scenarios: only viewed by the first viewer, only viewed by the second viewer, or viewed by both viewers. The process for shared viewing prediction begins with a “soft assignment” of the household television viewing event to one of the three scenarios. In an equivalent form, the process involves assigning one viewing probability to each of the two viewers, and each probability accounts for both solo viewing and shared viewing.

For a household of three or more viewers, the process of block 3, FIG. 1 still applies. However, in contrast to the two-viewer household scenario, in a three-viewer household (or larger), the audience size is estimated directly instead of assuming the audience size is 1+p (see discussion of Equation 1, below) as in the two-viewer household. This variation may be used because in a three-viewer or larger household, shared viewing could mean two viewers or three viewers (for a three-viewer household). Post-modeling stage processes for a household of three or more are described below.

More generally, regardless of household size, the process of measuring television viewing based on data from STB logs 1) estimates the effective viewership for each television viewing event, and 2) splits the estimate among all viewers.

Returning to the scenario of a two-viewer household, in an embodiment, as noted above, a first aspect of the prediction process includes two stages: first, predict shared viewing, and second, score individual viewing (i.e., block 3, FIG. 1). A second aspect (block 4, FIG. 1) then combines the results from the two stages of the first aspect.

For both stages, one set of predictive signals (i.e., the predictors X) comes from demographic data, such as household income, demographic region, number of children in the household, as well as each viewer's age, gender, education levels, and occupation, for example. Another set of predictive signals X comes from the set top box data, such as the time of the day, day of the week, channel, and genre keywords extracted from an electronic program guide, for example.

To predict shared viewing for one household for one television viewing event, the process of block 3A begins with the determination of y as an indicator of shared viewing or not for a vector of predictors X using a regression model such as:

log it(E[y|X])=log it(p)=Xβ, Eqn 1

where the expected value of y given X is p, and β is the coefficient vector of the predictors. Thus, if p is the probability of shared viewing, the estimated audience size for the television viewing event is 1+p, a value that is bounded between 1 and 2. The vector of predictors X includes household level demographics and television viewing event meta-information as noted above. For viewer-level demographics, such as age, gender, education levels, occupations types, the process uses an unordered combination of viewer-level variables. An example of such an unordered combination for gender has three levels: (female, female), (female, male), and (male, male). Other variables, such as education, may have many more than three levels. The first stage may be conducted for each predictor X.

Put another way, the model has been trained on metered data collected from individuals (i.e., panelists) in a high quality panel. The trained model then is used to predict shared viewing in the household data; that is, the shared viewing data obtained from the panelists is used to train the model, which in turn is used to predict shared viewing in a household. The household demographics are known (these data are supplied as part of the purchase of the STB log data). The STB log data also indicates when a television viewing event occurred in the household. The model then predicts if the television viewing event in the household was a shared viewing event or not. This completes the first stage of the prediction process (i.e., the first stage of the process of block 3, FIG. 1).

The second stage of the prediction scores individual viewing. In the second-stage, for each household television viewing event, a scoring process scores each viewer in the household to reflect the degree of confidence that the viewer has viewed that television viewing event. In this second stage of the prediction process, the score is determined as a product of two factors: (1) a probability of having television viewing, and (2) time-varying channel preferences measured in an amount of television viewing time.

Following the process of block 3, FIG. 1, a process is executed to combine the shared viewing prediction and individual viewing scores of block 3. Consider a household of two viewers. In the post-modeling process of block 4, FIG. 1, once the audience size p is estimated and the individual viewing score estimated, the two estimates may be combined as follows. For a television viewing event, the predicted shared viewing probability may be stated as p_{shared}. The individual viewing scores for the two viewers may be stated as score₁ and score₂. Then, given the television viewing event has been viewed by at least one viewer, the probability of having viewer 1 as the viewer is

$$\frac{{score}_{1}}{{score}_{1} + {score}_{2}} ( 1 + {p}_{shared} ) ,$$

and the probability of having viewer 2 as the viewer is

$$\frac{{score}_{1}}{{score}_{1} + {score}_{2}} ( 1 + {p}_{shared} ) .$$

As noted above, in a household of three or more viewers, the modeling process (block 3, FIG. 1) uses a same approach as that for a two-viewer household except that the audience size is estimated directly instead of being one (1) plus the probability (i.e., 1+p) of shared viewing. This modification accounts for the fact that shared viewing in, for example, a three-viewer household, could mean different combinations of two or more viewers saw the advertisement or program. Thus, if y represents the audience size (i.e., two viewers, three viewers, etc.) and n represents the household size, then:

$$logit ( E [ y \frac{y - 1}{n - 1} X ] ) = logit ( p ) = X β \qquad Eqn 2$$

where X is the vector of predictors. In the model represented by equation 2, the audience size estimation is scaled to fall between 0 and 1. This scaling allows use of the same model framework as in equation 1. The construction of the predictors follows that for a two-viewer household except for the combination of viewer-level demographics. For a demographic predictors with many possible levels, such as education, the combination of all viewer's variables may result in a very large number of levels. In an embodiment, the process of block 3 may use a percentage-based approach to valuing certain predictors X. For example, for the education level predictor, the value of X may be expressed as a percentage of the household that has reached a specified education level.

In executing the processes of FIG. 1, and as otherwise disclosed herein, individual viewer and household demographic and television viewing data may be collected and used. In situations in which the systems disclosed herein may collect and/or use personal information about panelists or other viewers (collectively, viewers), or may make use of personal information, the viewers may be provided with an opportunity to control whether programs or features collect viewer information (e.g., information about a viewer's social network, social actions or activities, profession, a viewer's preferences, or a viewer's current location), or to control whether and/or how to receive media, including advertisements, from an server that may be more relevant or of interest to the viewer. In addition, certain data may be treated in one or more ways before it is stored or used, so that personally identifiable information is removed. For example, a viewer's identity may be treated so that no personally identifiable information can be determined for the viewer, or a viewer's geographic location may be generalized where location information is obtained (such as to a city, ZIP code, or state level), so that a particular location of a viewer cannot be determined. Thus, the viewer may have control over how information is collected about the panelist and used by a server.

The process of FIG. 1 is described as applying to television viewing. However, the same process may apply to consumption of other media including Internet web site activity, radio, and other forms of electronic media.

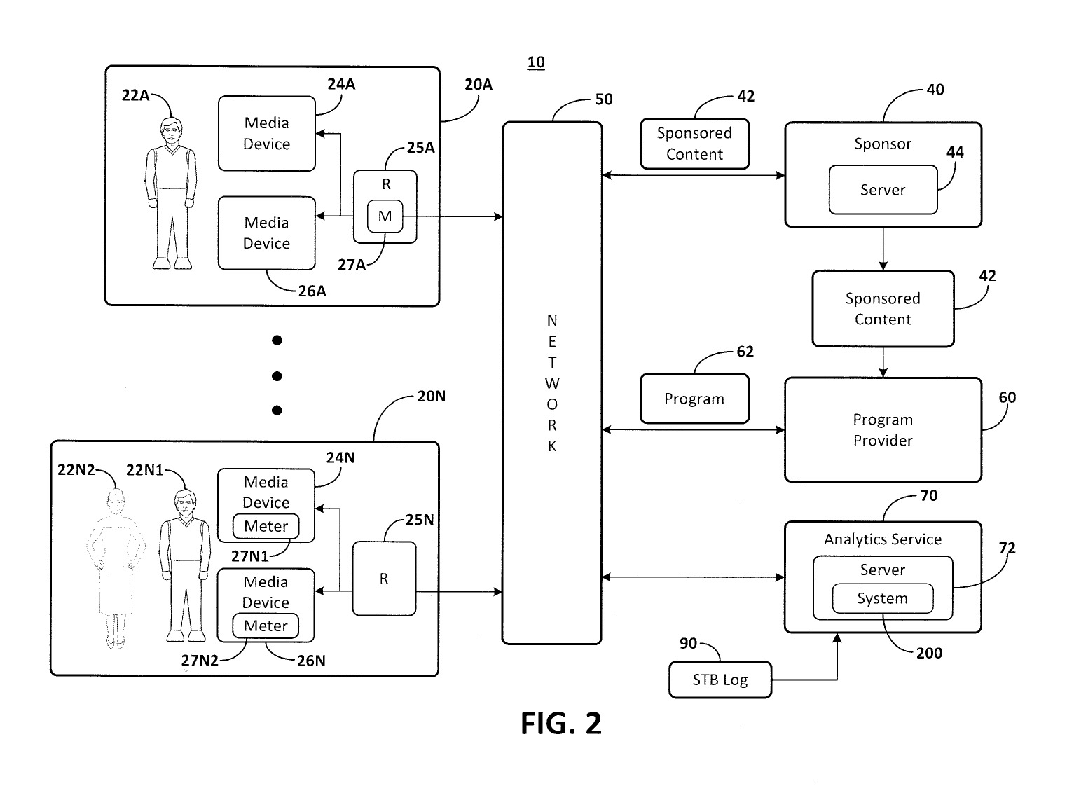

FIG. 2 illustrates an example environment in which media metrics may be estimated. The estimation may be based on STB log data applied to a model trained using observed demographics and viewing event data from a high quality panel. In FIG. 2, environment 10 includes viewing locations 20i, sponsor 40, program provider 60 and analytics service 70, all of which communicate using communications network 50. Although FIG. 1A shows these entities as separate and apart, at least some of the entities may be combined or related. For example, the sponsor 40 and analytics service 70 may be part of a single entity. Other combinations of entities are possible.

The viewing locations 20i include first media devices 24i and second media devices 26i through which viewers (e.g., panelists) 22i are exposed to media from sponsor 40 and program provider 60. A viewing location 20i may be the residence of a panelist 22i who operates media devices 24i and 26i to access, through router 25i, resources such as Web sites and to receive television programs, radio programs, and other media. The media devices 24i and 26i may be fixed or mobile. For example, media device 24i may be an Internet connected “smart” television (ITV); a “basic” or “smart” television connected to a set top box (STB) or other Internet-enabled device; a Blu-ray™ player; a game box; and a radio, for example. Media device 26i may be a tablet, a smart phone, a laptop computer, or a desk top computer, for example. The media devices 24i and 26i may include browsers. A browser may be a software application for retrieving, presenting, and traversing resources such as at the Web sites. The browser may record certain data related to the Web site visits. The media devices 24i and 26i also may include applications. The panelist 22i may cause the media devices 24i or 26i to execute an application, such as a mobile banking application, to access online banking services. The application may involve use of a browser or other means, including cellular means, to connect to the online banking services.

The viewing location 20A may be a single panelist viewing location and may include a meter 27A that records and reports data collected during exposure of sponsored content segments 42 and programs 62 to the panelist 22A. The example meter 27A may be incorporated into the router 25A through which all media received at the viewing location 20i passes.

Alternately, in an example of a tow-viewer viewing locations, panelists 22N1 and 22N2 operate media devices 24N and 26N. In operating these media devices, the panelists 22Ni may operate separate meters 27N1 and 27N2 for each media device. The meters 27N1 and 27N2 may send the collected data to the analytics service 70.

The sponsor 40 operates server 44 to provide sponsored content segments that are served with programs 62 provided by the program provider 60. For example, the server 44 may provide sponsored content segments to serve with broadcast television programming. The sponsored content segments 42 may include audio, video, and animation features. The sponsored content segments 42 may be in a rich media format. The sponsor 40 may provide a promotional campaign that includes sponsored content segments to be served across different media types or a single media type. The cross-media sponsored content segments 42 may be complementary; that is, related to the same product or service.

More specifically, the sponsor 40 may develop a promotional campaign to provide sponsored content segments for airing as part of a television broadcast and sponsored content segments for airing at one or more of the Web sites. In an alternative, the television portion of the promotional campaign may include both traditional sponsored content segments that air during the program breaks, product placement content displays, wherein specific products are incorporated into the television programs (e.g., a specific brand of automobile is used in a television comedy show), and content displays that may be placed in fixed positions in a television program (e.g., a content display for an automobile insurance company that appears on a stadium wall during airing of a soccer game). The online portion of the promotional campaign may include sponsored content segments that are shown on Web pages. The online sponsored content segments may use some creative features from corresponding television sponsored content segments. For example, an online sponsored content segment for an automobile company may show an image of a sport utility vehicle (SUV) that was promoted during a television program. The promotional campaign also may address other forms of media such as in mobile applications.

The network 50 may be any communications network that allows the transmission of signals, media, messages, voice, and data among the entities shown in FIG. 1, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless. The network 50 may be all or a portion of an enterprise or secured network. In an example, the network 50 may be a virtual private network (VPN) between the program provider 60 and the media devices 24A and 26A. While illustrated as a single or continuous network, the network 50 may be divided logically into various sub-nets or virtual networks, so long as at least a portion of the network 50 may facilitate communications among the entities of FIG. 1A.

The program provider 60 delivers programs for consumption by the panelists 22i and also for consumption by members of a large population from which the panelists 22i are recruited. The programs 62 may be broadcast television programs. Alternately, the programs 62 may be radio programs, Internet Web sites, or any other media. The programs 62 include provisions for serving and displaying sponsored content segments 42. The program provider 60 may receive the sponsored content segments 42 from the sponsor and incorporate the sponsored content segments into the programs 62. Alternately, the panelist's media devices may request a sponsored content segment 42 when those media devices display a program 62.

The analytics service 70, which operates analytics server 72, may collect data related to sponsored content segments 42 and programs 62 to which an panelist was exposed. In an embodiment, such data collection is performed through a panelist program where panelists 22 are recruited to voluntarily provide such data. The actual data collection may be performed by way of surveys and/or by collection by the meters 27. The collected data are sent to and stored in analytics server 72. The analytics service 70 also collects (or buys) STB log data 90 for a large population. The service 70 then processes the data according to program 200, stores the results of the processing, and may report the results to another entity such as the sponsor 40.

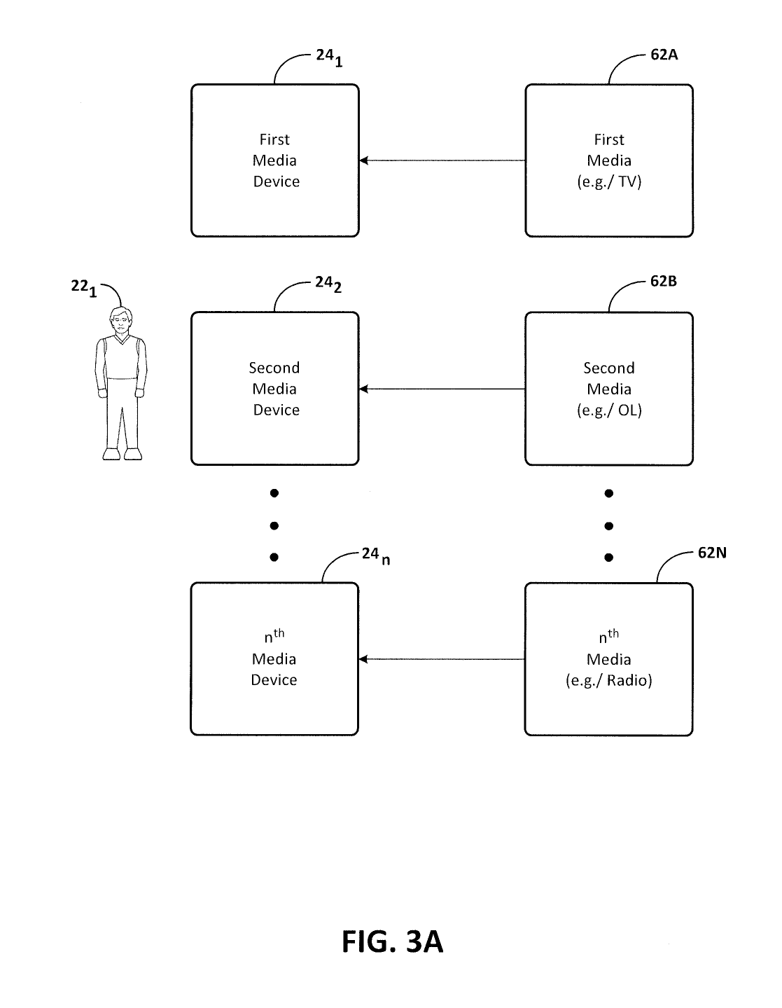

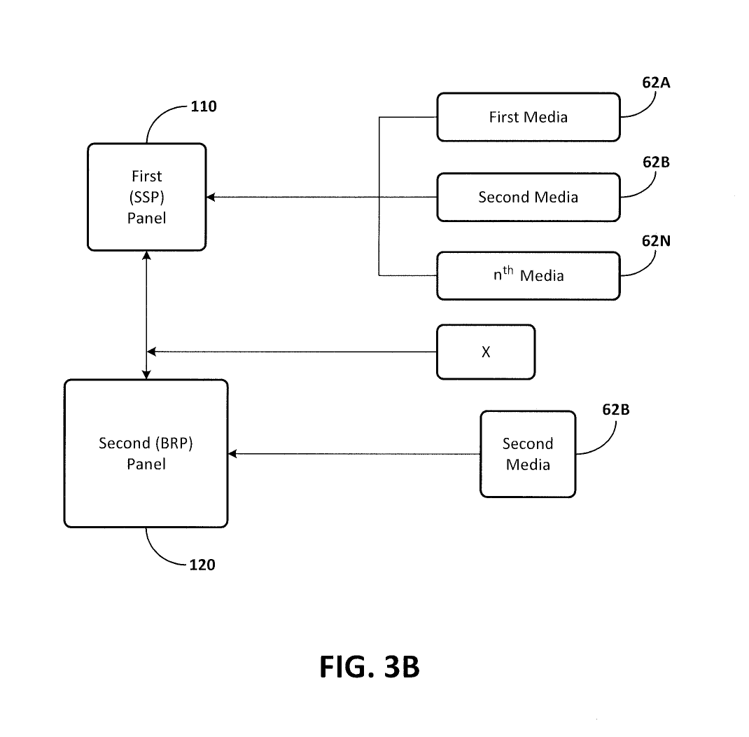

FIGS. 3A and 3B illustrate an example of media consumption and corresponding collection of media consumption data. In FIG. 3A, first media device 24ᵢ and second media device 24₂ under control of individual 22₁ receive, respectively, first media 62A and second media 62B from the program provider 60, and n^{th} media device 24ₙ receives n^{th} media 62N from the program provider 60. The first media 62A through the nth media 62N may be any type of media for which a measure of media consumption is desired. Alternatively, the collected data may be used when cross-platform interactivity is desirable. In an embodiment, consumption of broadcast television and associated television advertisements is a metric of interest to be estimated. However, other media, including specific aspects of television viewing may be of interest. For example, such media may include: a particular broadcast of a television program, a particular television channel or network, associated sponsored content segments, video on-demand, digital video recordings, or television in general; radio, such as a particular radio program, a particular radio station, or radio in general; the Internet, such as a particular Web site(s) or a genre of Web sites, as well as videos, audios, and sponsored content segments, including clickable sponsored content segments; print media, including newspapers; magazines, periodical publications, and books; outdoor sponsored content, such as billboards and signage; movie theater presentations, including pre-show sponsored content segments, trailers and product placements; in-store shopping, including interactive kiosks in shopping malls and centers; text messaging over smart phones; voice modules provided over telephones including land line phones and mobile phones; e-mail transmissions; and games, including computer games and Internet-based or online games.

FIG. 3B illustrates a relationship between or among a recruited panel and a population represented by STB log data. FIG. 3B illustrates a panel arrangement example in which a first panel (e.g., a single source panel) 110 receives data related to the first media 62A (e.g., broadcast television) and the second media 62B through the nth media 62N. A second panel (e.g., a broad reach panel) 120 receives only data related to one of the media. For example, the second panel 120 may receive only first media 62A data. For example, the second panel 120 may be a STB log data panel; alternately, the second panel 120 may be a separate recruited panel. Both panels 110 and 120 receive characteristic data X related to the individual panelists (i.e., viewers 22i).

The first panel 62A, as used in an aspect of the herein disclosed processes, may be a high quality panel of individuals who agree to record information related to their television viewing activities and to provide demographic data. High quality, as used herein means the data supplied by the panelists is accurate and complete. The panel 62A also, as noted above, may be a single source panel, in which media consumption for multiple media types is recorded by the panelists. However, for purposes of estimating media metrics according to the process of FIG. 1, the panel 62A need only record data associated with television viewing events.

A population is represented by data obtained through STB logs. The data may include demographic data for households and viewers in the households.

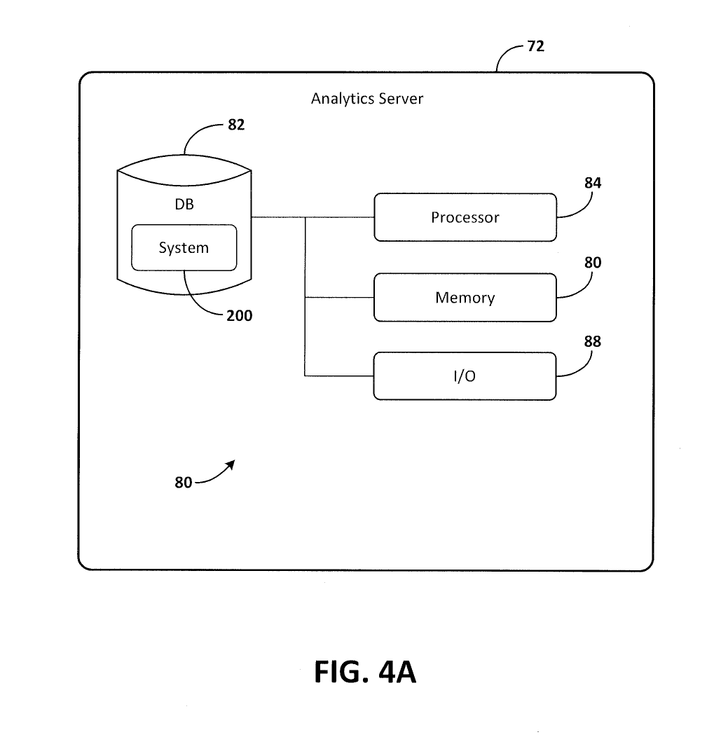

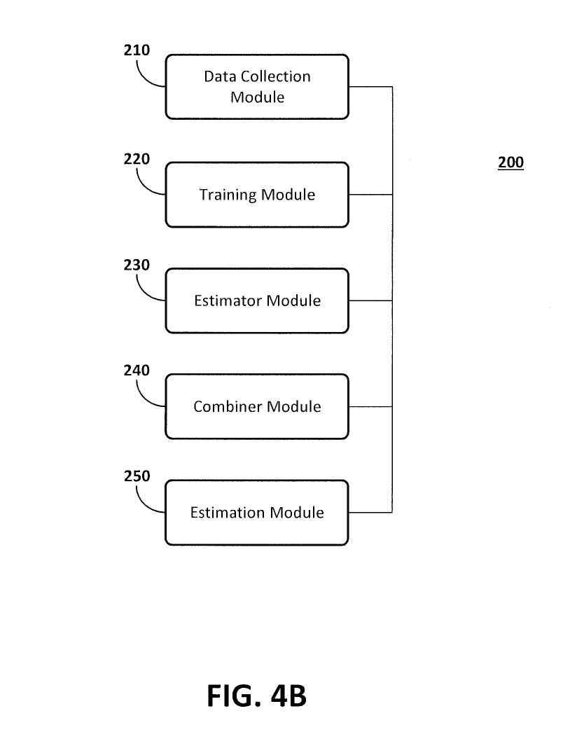

FIGS. 4A and 4B illustrate an example of a media consumption estimation system in which data from STB logs may be used to estimate television viewing. While the system of FIGS. 4A and 4B is described below in the context of television viewing, the same concepts may be used to estimate any media consumption metric.

In FIG. 4A system 80 is implemented on the analytics server 72 and includes database 82, processor 84, memory 86, and input/output (I/O) 88.

The database 82 includes a computer-readable storage medium on which is encoded the machine instructions comprising the system 200 (see FIG. 4B) and other programming needed to provide the services of the analytics service 70. The processor 84 loads the machine instructions into memory 86 and executes the machine instructions to perform data enhancement of media consumption metrics. The I/O 88 allows the analytics server 72 to communicate with other entities such as the server 44.

FIG. 4B illustrates example components of the system 200 of FIG. 4A. The system 200, as noted above, may be applied to measurement and analysis of media consumption metrics including a metric that is a continuous variable, such as the number of times an individual has been exposed to a sponsored content segment (which may range from zero to a very large number), or to a metric that is a binomial variable such as reach, which takes a value of zero or one. However, in the description that follows, the various modules of the system will be described primarily with respect to the problem of estimating large population viewing based on observed television event viewing data from a high quality panel, where the panel data are used to train a model that subsequent to training, is applied to data from the large population. The system further may be used to estimate media consumption metrics such as reach and incremental reach and TRP.

The system 200 may be used to provide an estimate of reach (and incremental reach) for arbitrary population subsets or sectors based on one or more characteristics X of the population or population subset or sector. Thus, a population may be divided according to those viewers having one or more characteristics X in common. In this approach, vector Xi represents population characteristics (variables), both demographics and viewing habits.

In FIG. 4B, system 200 includes data collection module 210, model training module 220, estimator module 230, combiner module 240, and media metrics estimation module 250.

The data collection module 210 includes the machine instructions to execute the processes of FIG. 1, block 1, including acquiring panelist data. The module 210 may format and store the panelist data for using in training a model.

The model training module 220 uses the acquired panelist data to train a model, such as a regression model.

The estimator module 230 also may be used to acquire, format, and save STB log data. The estimator module 230 applies a trained model to estimate shared viewing based on the household data from the STB log data and then to score individual viewing by viewers from the households providing the STB log data.

The combiner module 240 combines the predicted shared viewing and scored individual viewing according to the processes of block 4, FIG. 1.

The media metrics estimation module 250 estimates media metrics such as reach, TRP, and incremental reach. One use of granular-level (as described herein, individual viewer-level) estimated television viewing probabilities is to combine the viewer-level estimates to estimate campaign-level estimates. The ultimate goal of estimating granular level TV viewing probabilities is to compute aggregated campaign measures. One such campaign-level metric is television campaign reach. Given the viewer-level television viewing estimated derived from STB logs by using a model trained on a high quality panel, estimation of television campaign reach may proceed as follows, according to the herein disclosed systems.

First, the system 200 provides for the estimation of a viewer-level campaign reach indicator for each viewer. Second, the system 200 provides for computation of a weighted average of the viewer-level reach, where the weight adjusts for viewer representation in the high quality panel to compare to the actual demographic representation of similar viewers in the larger population represented by the STB logs:

$$\frac{{Σ}_{i} {r}_{i} {w}_{i}}{{Σ}_{i} {w}_{i}} \qquad Eqn 3$$

Using the STB log data, the system 200 replaces the observed viewer-level campaign reach with an estimated reach probability. Next, the system 200 translates the viewing probabilities of a sequence of television viewing events that contain a specific sponsored event or advertisement to the estimated reach probability. Assuming that all sponsored events in a campaign are viewed independently of each other, the overall reach probability may be stated as:

\hat{r}ᵢ=1−Πₖ(1−pₖ) Eqn 4

Another widely-used television viewing metric is television target rating point (TRP), which may be defined as the product of overall campaign reach and average reach frequency within a specific population. TRP may be computed by summing viewer-level reach frequency within the population. The process for computing TRP begins with computation of viewer-level campaign reach frequency fᵢ for each viewer i. As before, viewer-level campaign reach frequency for each panelist may be observed, and the data used to train a model, which in turn is applied to the larger population represented by the STB log data. The overall campaign reach for the population represented by the STB log data then is:

$$\frac{{Σ}_{i} {f}_{i} {w}_{i}}{{Σ}_{i} {w}_{i}} \qquad Eqn 5$$

where wᵢ is a weight adjusting the demographic representation of the viewer in the population.

Next, the process, using the STB log data, estimates viewer reach frequency based on the viewing probabilities of a sequence of events that contain campaign-level events. Viewer-level reach frequency may be stated as

\hat{f}ᵢ=Σₖpₖ. Eqn 6

This computation does not rely on an assumption of independence among campaign-level sponsored event viewing.

The above-disclosed systems and processes also may be applied to estimate incremental reach based on the STB log data. Incremental reach may be defined as a number of unique viewers exposed to advertising from a specific campaign, via a specific media channel, who were not exposed to advertising from that specific campaign on any other media channel. For example, a viewer may be exposed to an advertisement on a television broadcast but was not exposed to the same or a similar advertisement online. Thus, the STB log data may be combined with online panel data to build a single source panel to measure cross-media usage. Then, the probabilistic television viewing data may be leveraged to produce cross-media campaign measures, such as incremental reach of online video advertising to relative to television advertising.

To estimate incremental reach, the system 200 estimates a second reach metric such as online reach. In this example, for each viewer i, the television reach for a specific campaign may be expressed as rᵢ and online reach for the campaign as Overall incremental reach may be estimated by first computing viewer-level incremental reach as rᵢ′(1−rᵢ) for user i. Next, the system 200 computes a weighted average of the viewer-level incremental reach according to

$$\frac{{Σ}_{i} {r}_{i}^{′} ( 1 - {r}_{i} ) {w}_{i}}{{Σ}_{i} {w}_{i}} ,$$

where wᵢ is used to adjust viewer i according to the viewer's demographic representation.

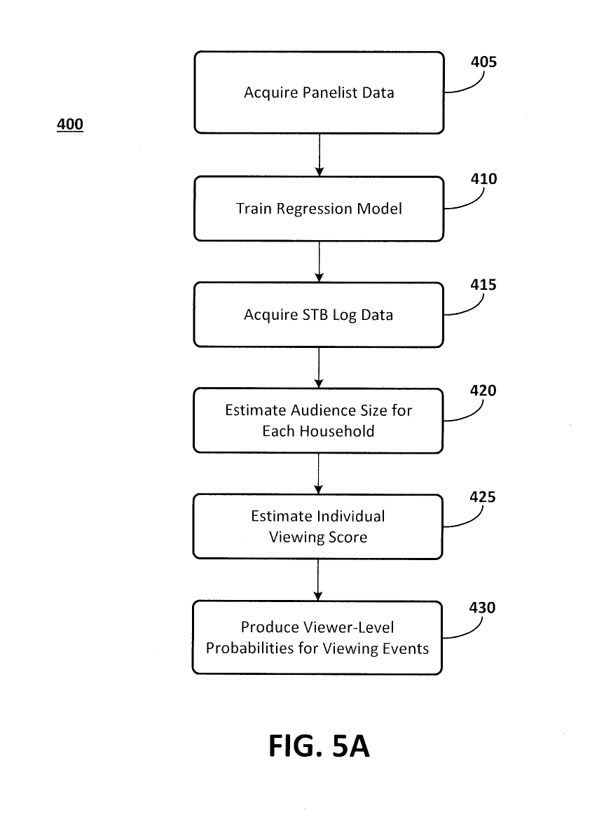

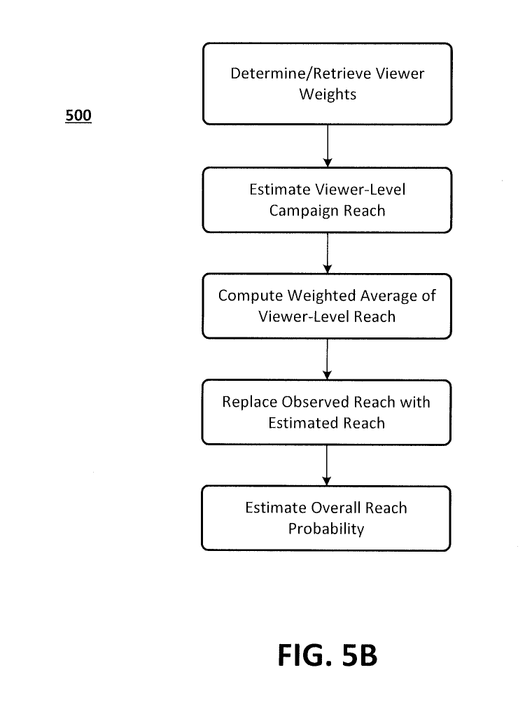

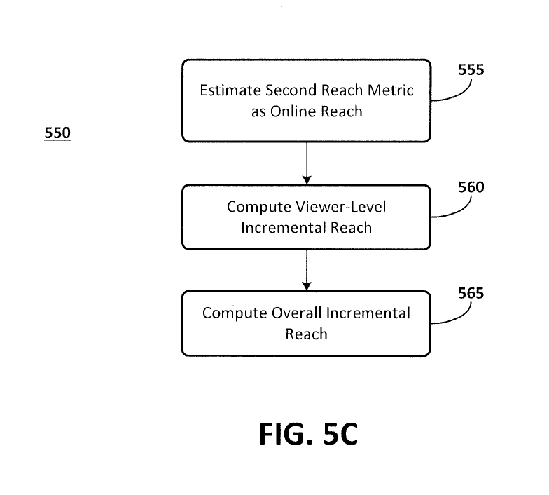

FIGS. 5A-5C are flowcharts illustrating example media consumption estimation methods executed by the systems of FIGS. 4A and 4B according to the processes of FIG. 1.

FIG. 5A illustrates metrics estimation process 400. In FIG. 5A, process 400 begins in block 405 when the system 200 acquires a sufficient sample of panelist data. Note that the sample may not include all the demographic features and segments of the larger sample from which the panel is drawn. The panel data may be formatted and stored in the data store 82.

In block 410, the system 200 trains a regression model using the observed panelist data. In block 415, the system 200 acquires STB log data from a large population. The system 200 may format and store the STB log data.

In block 420, the system 200 estimates audience size in each household represented by the STB log data. In block 425, the system estimates an individual viewing score for each individual viewer in a household. In block 430, the system 200 combines the estimated audience size and the viewing score to produce viewer-level probabilities for each viewer in each household for each household television viewing event. The process 400 then ends.

FIG. 5B is a flowchart illustrating an example method 500 for estimating viewer-level television reach and overall television reach for a specific campaign. In FIG. 5B, block 505 the system 200 retrieves or determines viewer weights wᵢ according to representation of a particular viewer demographic in the high quality panel relative to the same demographics in the larger population. In block 510, the system 200 estimates a viewer-level campaign reach indicator rᵢ for each viewer. In block 515 system 200 computes a weighted average of the viewer-level reach according to

$$\frac{{Σ}_{i} {r}_{i} {w}_{i}}{{Σ}_{i} {w}_{i}} .$$

Using the STB log data, in block 520, the system 200 replaces the observed viewer-level campaign reach with an estimated reach probability. In block 525, the system 200 translates the viewing probabilities of a sequence of television viewing events that contain a specific sponsored event or advertisement to the estimated reach probability to provide the overall reach probability according to \hat{r}ᵢ=1−Πₖ(1−pₖ). The method 500 then ends.

FIG. 5C is a flowchart illustrating an example method for estimating incremental reach for a specific campaign. In FIG. 5C, method 550 begins in block 555 when the system 200 obtains or estimates a second reach metric such as online reach. In this example method 550, for each viewer i, the television reach for a specific campaign may be expressed as rᵢ and online reach for the campaign as rᵢ′. In block 560, the system 200 computes viewer-level incremental reach as rᵢ′(1−rᵢ) for user i. In block 565, the system 200 computes overall incremental reach as a weighted average of the viewer-level incremental reach according to

$$\frac{{Σ}_{i} {r}_{i}^{′} ( 1 - {r}_{i} ) {w}_{i}}{{Σ}_{i} {w}_{i}} .$$

The method 550 then ends.

Certain of the devices shown in the herein described figures include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to flowcharts and accompanying descriptions to illustrate the embodiments represented in FIGS. 5A-5C. The disclosed devices, components, and systems contemplate using or implementing any suitable technique for performing the steps illustrated. Thus, FIGS. 5A-5C are for illustration purposes only and the described or similar steps may be performed at any appropriate time, including concurrently, individually, or in combination. In addition, many of the steps in the flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

1. A method for estimating media metrics from population data, comprising:
measuring, by a server comprising a processor, first viewing data of a plurality of individual panelists drawn from a first population;
obtaining, by the server, demographic data drawn from the first population;
formatting and storing, by the processor of the server, the measured first viewing data and the obtained demographic data for the plurality of panelists;
measuring, by a set top box (STB), household-level viewing data and household level demographics drawn from a second population, separate from the first population;
estimating, by the processor, a viewing audience size of a household in the second population for a first viewing event by multiplying a first characteristics vector for the household in the second population by a coefficient vector, generated by a server as coefficient values for a multiplication of the coefficient vector and a second characteristics vector of a plurality of households in the first population to calculate an inverse of a logistic transform of a probability of viewing audience size for the households in the first population;
calculating, by the processor, a viewing score for each individual viewer for the first viewing event in a plurality of households in the second population data; and
calculating, by the processor for each viewer in a household in the second population, a probability that the viewer viewed the first viewing event by combining the estimate of viewing audience size and the calculated viewing score.

2. The method of claim 1, wherein the first viewing event is a television viewing event defined as a continuous view of television programming on a particular television channel.

3. The method of claim 2, further comprising:
estimating, by the processor, a second viewing audience size of a household in the second population for a second television viewing event by multiplying a second characteristics vector for the household in the second population by the coefficient vector generated by the server;
calculating, by the processor, a second viewing score for each individual viewer for the second viewing event in the plurality of households in the second population data; and
calculating, by the processor for each viewer in a household in the second population, a probability that the viewer viewed the second viewing event by combining the estimate of second viewing audience size and the calculated second viewing score.

4. The method of claim 3, wherein the first and second television viewing events comprises a sequence of television viewing events, and wherein the sequence of television viewing events comprises sponsored events and television programs.

5. The method of claim 1, wherein the household level demographics are represented by a vector of predictors X,
the first characteristics vector and the second characteristic vector are characteristic vectors of a first predictor and the coefficient vector generated by the server is a coefficient vector of the first predictor, and
wherein the method further comprises:
estimating, by the processor, a second viewing audience size of a household in the second population for the first viewing event by multiplying a first characteristics vector of a second predictor for the household in the second population by a coefficient vector of the second predictor, generated by the server as coefficient values for a multiplication of the coefficient vector of the second predictor and a second characteristics vector of the second predictor of the plurality of households in the first population to calculate an inverse of a logistic transform of a probability of viewing audience size for the households in the first population; and
calculating, by the processor for each viewer in a household in the second population, a probability that the viewer viewed the first viewing event by combining the estimate of second audience size and the calculated viewing score.

6. The method of claim 5, further comprising:
determining, by the processor, for each viewer i of a plurality of viewers in the second population, weights wᵢ according to representation of a particular viewer demographic comprising the panelist in the panel relative to the same demographic of viewers in the second population;
estimating, by the processor, a viewer-level campaign reach indicator rᵢ for each viewer i of the plurality of viewers in the second population;
computing, by the processor, a weighted average of viewer-level reach according to
$$\frac{{Σ}_{i} {r}_{i} {w}_{i}}{{Σ}_{i} {w}_{i}} .$$
computing, by the processor, for each viewing event k that contains a specific sponsored event, viewing probabilities pₖ of the sequence of television viewing events that contain the specific sponsored event; and
computing, by the processor, an overall reach probability rᵢ according to \hat{r}ᵢ=1−Πₖ(1−pₖ).

7. The method of claim 5, further comprising:
receiving, by the processor for each viewer i, television reach for a specific campaign rᵢ and online reach for the campaign as
computing, by the processor, viewer-level incremental reach as rᵢ′(1−rᵢ) for viewer i; and
computing, by the processor, overall incremental reach as a weighted average of the viewer-level incremental reach according to
$$\frac{{Σ}_{i} {r}_{i}^{′} ( 1 - {r}_{i} ) {w}_{i}}{{Σ}_{i} {w}_{i}} ,$$
wherein wᵢ is a weight adjusting a demographic representation of each viewer i in the second population.

8. The method of claim 1, wherein the second population data are represented in STB logs.

9. The method of claim 1, wherein the estimating the viewing audience size comprises applying a regression model to the second population.

10. A system for estimating media metrics from population data, comprising:
a processor; and
a computer readable storage medium comprising a program of instructions executable by the processor for estimating media metrics, wherein when the instructions are executed, the processor:
measures first viewing data of a plurality of individual panelists drawn from a first population;
obtains, via the STB, demographic data drawn from the first population;
measure, via set top box (STB), household-level viewing data and household level demographics drawn from a second population, separate from the first population;
estimates a viewing audience size of a household in the second population for a first viewing event by multiplying a first characteristics vector for the household in the second population by a coefficient vector, generated by a server as coefficient values for a multiplication of the coefficient vector and a second characteristics vector of a plurality of households in the first population to calculate an inverse of a logistic transform of a probability of viewing audience size for the households in the first population;
calculates a viewing score for each individual viewer for the first viewing event in one or more households in the second population; and
calculates, for each viewer in the one or more household in the second population, a probability that the viewer viewed the first viewing event by combining the viewing audience size estimate and the calculated viewing score.

11. The system of claim 10, wherein the first viewing event is a television viewing event defined as a continuous view of television programming on a particular television channel.

12. The method of claim 11, wherein the processor is further configured to:
estimate a second viewing audience size of a household in the second population for a second television viewing event by multiplying a second characteristics vector for the household in the second population by the coefficient vector generated by the server;
calculate a second viewing score for each individual viewer for the second television viewing event in one or more households in the second population; and
calculate, for each viewer in the one or more household in the second population, a probability that the viewer viewed the second television viewing event by combining the second audience size estimate and the calculated second viewing score.

13. The method of claim 12, wherein the first and second television viewing events comprises a sequence of television viewing events, and wherein the sequence of television viewing events comprises sponsored events and television programs.

14. The system of claim 10, wherein the household level demographics are represented by a vector of predictors X,
the first characteristics vector and the second characteristic vector are characteristic vectors of a first predictor and the coefficient vector generated by the server is a coefficient vector of the first predictor, and
wherein the processor is further configured to:
estimate a second viewing audience size of a household in the second population for the first viewing event by multiplying a first characteristics vector of a second predictor for the household in the second population by a coefficient vector of a second predictor, generated by the server as coefficient values for a multiplication of the coefficient vector of the second predictor and a second characteristics vector of the first predictor of the plurality of households in the first population to calculate an inverse of a logistic transform of a probability of viewing audience size for the households in the first population; and
calculate, for each viewer in the one or more household in the second population, a probability that the viewer viewed the first viewing event by combining the second viewing audience size estimate and the calculated viewing score.

15. The system of 14, wherein the processor:
determines, for each viewer i of a plurality of viewers in the second population, weights wᵢ according to representation of a particular viewer demographic comprising the panelist in the panel relative to the same demographic of viewers in the second population;
estimates a viewer-level campaign reach indicator rᵢ for each viewer i of the plurality of viewers in the second population;
computes a weighted average of viewer-level reach according to
$$\frac{{Σ}_{i} {r}_{i} {w}_{i}}{{Σ}_{i} {w}_{i}} .$$
computes, for each viewing event k that contains a specific sponsored event, viewing probabilities pₖ of the sequence of television viewing events that contain the specific sponsored event; and
computes an overall reach probability rᵢ according to \hat{r}ᵢ=1−Πₖ(1−pₖ).

16. The system of claim 14, wherein the processor:
observes viewer-level reach frequency from the measured first viewing data and the demographic data;
trains a model according to the observer viewer-level reach data;
applies the trained model to household-level data from the second population to estimate viewer-level reach frequency; and
sums the estimated viewer-level reach frequency to produce television target rating point data.

17. A method for estimating media consumption metrics, comprising:
measuring, by a server comprising a processor, first data of a panel of media viewers, drawn from a first population;
observing demographic and viewing predictors from the measured first data;
and
estimating, by the processor of the server, a probability that each of viewers in a plurality of households in a second population, separate from the first population, viewed a specific media event by applying a regression model that calculates an inverse of a logistic transform of a probability of viewing audience size of a plurality of households in the first population for the specific media event by multiplying a vector of the viewing predictors and a coefficient vector of the model, to the second population, the households of the second population described by household demographic and television viewing event predictors.

18. The method of claim 17, wherein estimating the probabilities comprises:
estimating a viewing audience size for one or more households in the second population and computing a viewing score for each individual viewer in the one or more households; and
combining the audience size estimate and the viewing score to produce the probability estimates.

19. The method of claim 17, where in the media is broadcast television, and the specific media event is a television viewing event defined as a time a television is tuned to a specific channel.

20. The method of claim 17, wherein a household comprises two or more viewers, and wherein the size of the audience is determined for shared viewing and non-shared viewing, and wherein shared viewing comprises viewing by at least two viewers in the household.
